(19) United States
(12) Patent Application Publication
(10) Pub. No.: US 2004/0027615 A1
(43) Pub. Date: Feb. 12, 2004

(54) Image forming apparatus and image forming method

(75) Inventor: Hiroyuki Okuyama, Mishima-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/391,804

(22) Filed: Mar. 20, 2003

(30) Foreign Application Priority Data
Apr. 2, 2002 (JP) 2002-100487

(51) Int. Cl. G06F 3/12; H04N 1/40

(52) U.S. Cl. 358/2.1; 358/1.13

(57) ABSTRACT

An image forming apparatus has a region identifying section which receives first image information DAT_{C} from a scanner and outputs a first region identifying signal DSC_{C}, a transforming look-up table which receives second image information DAT_{P} from a printer controller and attribute information TAG, and transforms them into second identifying information DSC_{P} of a standard common with that of the first region identifying signal by using a transforming table, a high image quality processing section which processes the image information in accordance with these identifying information, and a printer engine which forms an image in accordance with the processed image information. Because the identifying information are common, for example, due to circuits of the high image quality processing section being used in common, a reduction in costs is aimed for.

### BACKGROUND OF THE INVENTION

The present invention relates to an image forming apparatus, and in particular, to an image forming apparatus which forms image information acquired from not only a scanner, but also a printer controller, into an image.

Recently, accompanying improvements in the performances of image forming apparatuses such as digital copying machines or the like, integrated digital devices having not only a copying function, but also a function as a printer, have been developed and become popular. In such an MFP device having a copying function and a printing function, in a conventional apparatus, image processings of the copying function and the printing function are separately carried out, and the internal processings are switched by identifying signals (attribute signals) which are characteristic of the respective image processings. In accordance therewith, the optimum image processing corresponding to the image regions can be carried out, and it is possible to realize high image quality. At this time, with respect to the copying function and the printing function, regardless of the fact that the structures carrying out the processings in accordance with the identifying signals have a large number of portions functionally common, circuits are prepared and processings are carried out independently at each. Accordingly, when considering such waste, it is difficult to say that the costs of the product have been sufficiently reduced.

Namely, in the conventional apparatus, regardless of the fact that the processing circuits, which carry out processings particularly in accordance with the identifying signals, of the copying function, the printing function, or the like have a large number of portions which are functionally common, the copying function, the printing function, and the like have respective and independent circuits. Therefore, there is the problem that the cost of the product cannot be sufficiently reduced.

### BRIEF SUMMARY OF THE INVENTION

An object of the present invention is to provide an image forming apparatus and an image forming method which can realize a reduction in costs due to a processing of identifying information of a copying function and a processing of identifying information of a printer function being made common.

In order to achieve the above object, according to an aspect of the present invention, there is provided an image forming apparatus comprising: an identifying section which receives first image information, carries out region identifying processing of the first image information, and outputs a first region identifying signal; a transforming section which receives second image information that is different from the first image information and attribute information of the second image information, and transforms the attribute information into a second region identifying signal of a standard common with that of the first region identifying signal by using a transforming table; and an image forming section which receives at least one of the first image information and the first region identifying signal, and the second image information and the second region identifying signal, and which, on the basis thereof, carries out image formation on a recording medium.

The present invention can realize the same functions in the copy image processing and the printer image processing by the same circuit due to, for example, identifying signals of an image signal from a printer controller and an image signal from a scanner being made common, as in a conventional apparatus. In accordance therewith, a reduction in costs can be realized by making the structure of the apparatus be small-scale.

### BRIEF DESCRIPTION OF THE SEVERAL VIEWS OF THE DRAWING

FIG. 1 is a block diagram showing mainly an image processing unit which is an embodiment of an image processing apparatus according to the present invention.

FIG. 2 is a block diagram showing switching of the internal processings at an output high image quality processing section of the image processing apparatus according to the present invention.

FIG. 3 is a view for explanation of inking processing and gradation processing in accordance with region identifying signals and attribute signals of the image forming apparatus according to the present invention.

FIGS. 4A and 4B are graphs showing two inking ratios of the inking processing of the image forming apparatus according to the present invention.

FIG. 5 is a sectional view showing the structure of the image forming apparatus according to the present invention; and

FIG. 6 is a block diagram showing the configuration of the image forming apparatus according to the present invention.

### DETAILED DESCRIPTION OF THE INVENTION

Hereinafter, an embodiment of an image forming apparatus according to the present invention will be described in detail with reference to the drawings.

The present invention is an image forming apparatus which carries out image formation by receiving a plurality of different image information from a scanner, a printer controller, or the like, and aims for a reduction in the cost of the image forming apparatus by converting different identifying signals (attribute signals) into a common standard signal and making a processing circuit, which is carried out in accordance with the identifying signals, common.

<One Example of the Image Forming Apparatus According to the Present Invention>

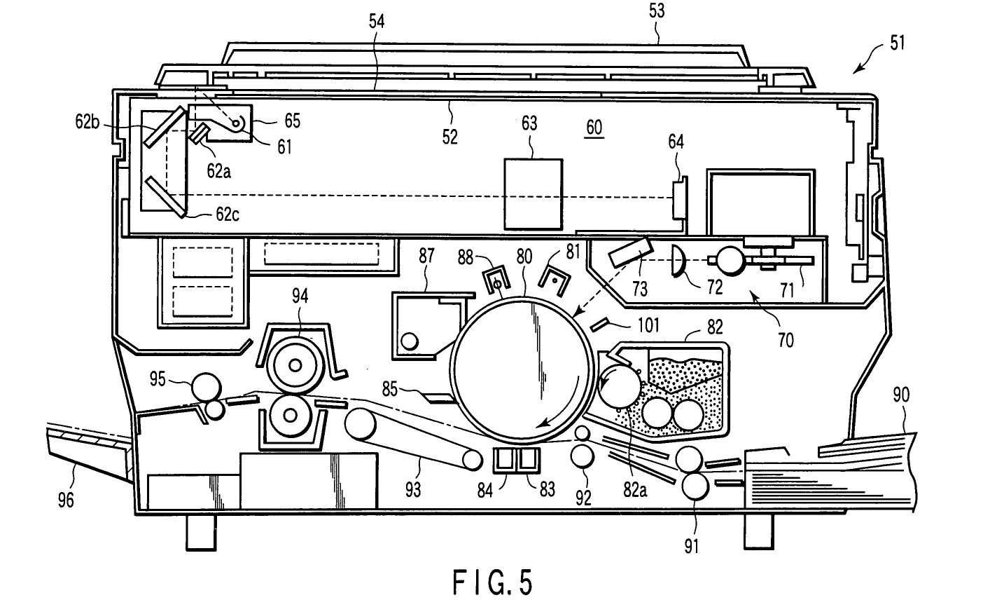

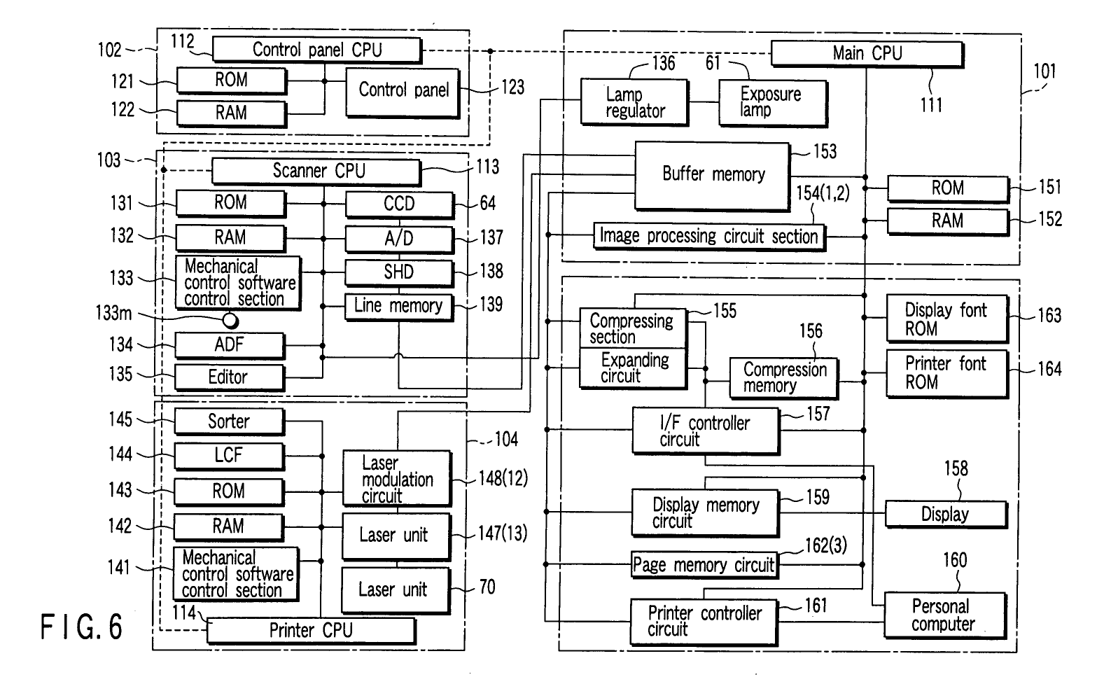

One example of an image forming apparatus to which the present invention is applied will be described in detail with reference to the drawings. FIG. 5 is a sectional view showing the structure of the image forming apparatus according to the present invention. FIG. 6 is a block diagram showing the configuration of the image forming apparatus according to the present invention.

First, in the image forming apparatus shown in FIG. 5, for example, an electronic copying machine, a document stand (glass plate) 52 for placing a document is provided at the upper portion of a main body 51. A document stand cover 53 is provided so as to freely open and close on the document stand 52. A document 54 is appropriately set on the document stand 52.

An exposure system 60 is provided at the upper portion in the main body 51. The exposure system 60 is structured from an exposing section provided so as to face the bottom surface of the document stand 52, for example, an exposure lamp 61, first through third reflecting mirrors 62a, 62b, 62c, and a variable power lens block 63, and an image signal outputting section, for example, a CCD type line sensor (hereinafter, called CCD sensor) 64.

The exposure lamp 61 is provided at a carriage (CRG) 65 which is a moving section, and freely moves reciprocally, and exposure scanning is carried out over the entire surface of the document stand 52 by forward movement of the carriage 65 toward the right in the drawing and light emission of the exposure lamp 61. A reflected light image of the document 54 placed on the document stand 52 is obtained by the exposure scanning, and the reflected light image is projected onto the CCD sensor 64 by the respective reflecting mirrors and the variable power lens block 63. The CCD sensor 64 outputs an image signal of a level corresponding to the amount of received light. The image signal is transmitted to the image processing section, and thereafter, is transmitted to a laser unit 70.

A photosensitive body drum 80 which is freely rotated in the direction of the arrow is provided as an image carrier at substantially central portion in the main body 51. At the outer periphery of the photosensitive body drum 80, a charging charger 81, the aforementioned laser unit 70, a developing device 82, a transfer charger 83, a peeling charger 84, a peeling pawl 85, a cleaner 87, and a discharging lamp 88 are successively disposed.

The laser unit 70 has a first lens, a laser deflector 71, a focusing lens 72, a mirror 73, and the like. The first lens provides convergence to the laser beam generated from a semiconductor laser element (not shown), and converts it into a laser beam having a substantially circular cross-sectional configuration. The laser deflector 71 deflects the laser beam having passed through the first lens along the axial direction of the photosensitive body drum 80. The focusing lens 72 makes the deflection angle of the laser beam and the distance from the optical axis on the photosensitive body drum 80 to the position where the beam is to be focused coincide in order to successively make the laser beam deflected by the laser deflector 71 be focused on the photosensitive body drum 80. The mirror 73 guides the laser beam having passed through the image-forming lens 72 onto the photosensitive body drum 80.

The charging charger 81 charges electrostatic charge on the surface of the photosensitive body drum 80 by applying a high voltage supplied from a charging high voltage transformer (not shown) to the photosensitive body drum 80 by a corona wire.

Due to the charging and the focusing on the photosensitive body drum 80 by the laser beam of the laser unit 70, an electrostatic latent image is formed on the photosensitive body drum 80.

The developing device 82 accommodates a two-component developer formed from non-magnetic toner and a magnetic carrier, and has a developing roller 82a for supplying the developer to the photosensitive body drum 80.

The developing roller 82a adheres only the toner charged negative to the electrostatic latent image on the photosensitive body drum 80 while holding the developer on the outer periphery. Due to this adhesion, the electrostatic latent image on the photosensitive body drum 80 is made to be a visible image. In order to carry out this development, developing bias voltage of a predetermined level is applied to the developing roller 82a and the developer from a developing bias generating circuit (not shown).

Further, the developing roller 82a is structured from a magnet roller at which the S pole and the N pole are disposed in the circumferential direction, and a non-magnetic sleeve rotating in the direction of the arrow on the periphery of the magnet roller. On the sleeve, spikes (spike rows) of the carrier are formed so as to be along the line of magnetic force of the magnetic roller. The toner adheres to the ears of the carrier by image force, and the toner is moved to the photosensitive body drum 80 side by the electric field formed by the developing bias voltage and the surface potential of the photosensitive body drum 80 at the developing position where the photosensitive body drum 80 and the developing roller 82a face one another.

A plurality of paper feeding cassettes 90 are provided as a paper feeding section at the bottom portion in the main body 51. A large number of copy papers whose sizes are different from one another are accommodated as image forming media in these paper feeding cassettes 90. In accordance with an ON-operation of the copy keys at a control panel (operation panel) 123 which will be described later, and in accordance with the sensed results of a document size sensor (not shown), the copy papers are taken out one-by-one from one of the respective paper feeding cassettes 90 by a pickup roller (not shown). The taken-out copy paper is delivered to an aligning roller 92, and waits for the rotation of the photosensitive body drum 80.

The aligning roller 92 corrects the inclination of the copy paper, and adjusts the front end of the toner image on the photosensitive body drum 80 and the front end of the copy paper, and carries out feeding of the copy paper at the same speed as the travelling speed of the outer peripheral surface at the photosensitive body drum 80. Note that an aligning switch (not shown) for sensing the front end of the copy paper is disposed at the vicinity of the aligning roller 92 in order to control the operational timing of the aligning roller 92.

The transfer charger 83 transfers the appeared image (toner) on the photosensitive body drum 80 onto the copy paper by applying a high voltage supplied from a transfer high voltage transformer (not shown) to the copy paper fed from the aligning roller 92 in synchronization with the rotation of the photosensitive body drum 80.

The peeling charger 84 peels the copy paper from the photosensitive body drum 80 by applying a high voltage applied from a peeling high voltage transformer (not shown) to the copy paper by a corona wire.

The peeling pawl 85 acts to help peeling of the copy paper by the peeling charger 84.

The cleaner 87 scrapes and recovers the non-transferred toner remaining at the surface of the photosensitive body drum 80. The toner recovered is collected in a toner recovery device (not shown), and is disposed of each time when the toner reaches a predetermined amount.

The discharging lamp 88 operates to emit light by a voltage supplied from a light source driver (not shown), and removes the remaining electric potential remaining at the photosensitive body drum 80.

The copy paper peeled by the above-described peeling charger 84 is fed to a fixing machine (heat roller) 94 by a conveying belt 93. The fixing machine 94 fixes the appeared image transferred on the copy paper, on the copy paper by heating/compressing.

The copy paper on which fixing has been carried out is discharged to a paper discharging tray 96 by a paper discharging roller 95. A paper discharging switch (not shown) is disposed in the vicinity of the paper discharging roller 95. Due to the paper discharging switch sensing the training end of the copy paper, the image forming operation on the copy paper is completed.

(Control System)

Next, a control system carrying out control of the electronic copier will be described with reference to FIG. 6. In FIG. 6, a control panel CPU 112, a scanner CPU 113, and a printer CPU 114 are connected to a main CPU (central processing unit) 111 via communication lines. The main CPU 111 generally controls these control panel CPU 112, scanner CPU 113, and printer CPU 114, and carries out overall control of copying.

A ROM (read only memory) 121, a RAM (random access memory) 122, and a control panel (operating panel) 123 are connected to the control panel CPU 112. The control panel CPU 112 carries out sensing of the operations of the switches (including switches for setting the enlargement/reduction ratio and paper size) on the control panel 123, turning-on and turning-off of LEDs, control of indicators, and the like.

A ROM 131, a RAM 132, a control section 133 such as mechanical control software such as a motor solenoid switch or the like, an ADF (automatic document feeder) 134, an editor (coordinate inputting device) 135, an A/D circuit (analog-to-digital conversion circuit) 137 converting an analog image signal outputted from the aforementioned CCD sensor 64 into an image signal of, for example, 8 bits, a shading correction circuit (SHD) 138, and a line memory 139 are connected to the scanner CPU 113. A pulse motor for moving the carriage 65 in a sub-scanning direction is connected to the control section 133. Moreover, the exposure lamp 61 is connected to the scanner CPU 113 via a lamp regulator 136.

A control section 141, such as mechanical control software such as a motor solenoid switch or the like, a RAM 142, a ROM 143, an LCF (large cassette feeder) 144, a sorter 145, a laser driver 147 for driving a laser unit 20, and a laser modulation circuit 148 are connected to the printer CPU 114.

Moreover, a ROM 151, a RAM 152, a data switching and buffer memory circuit 153 which carries out switching of where the data read at the scanner section 103 is sent to and which data is sent to a printer engine, and buffering, an image processing section 154 carrying out pictorial processing with respect to an image signal, a compressing/expanding circuit 155 carrying out compression and expansion of an image signal, a compression memory 156 storing data compressed at the compressing/expanding circuit 155, an I/F controller circuit 157 carrying out interfacing with a hard disk drive/an optical disk drive/a facsimile adapter, a display memory circuit 159 for storing the image signal displayed on a display 158, a printer controller 161 for expanding code data of a personal computer 160 into an image signal, a page memory circuit 162 storing image signal for each page, a display font ROM 163 for expanding code data on the display 158, and a print font ROM 164 for expanding code data on the page memory circuit 162 are connected to the main CPU 111.

Such a configuration can be broadly divided into a basic processing section 101, a control panel 102, a scanner section 103, and a printer engine 104.

<Image Processing Section of the Image Forming Apparatus According to the Present Invention>

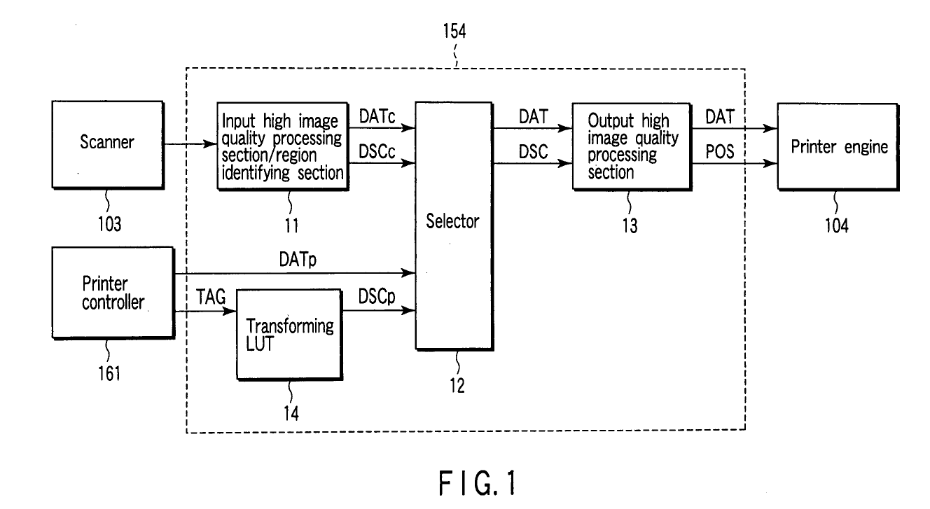

In a control system having such a configuration, the above-described image forming apparatus according to the present invention has the configuration shown in FIG. 1 as one portion of the image processing section 154. FIG. 1 is a block diagram of the image processing section in accordance with the present invention.

In FIG. 1, the image processing section 154 has a high image quality processing section/region identifying section 11 to which an image signal DAT is supplied from the scanner 103, and a selector 12 to which an image signal DAT_{C} and an identifying signal DSC_{C} are supplied. Further, the printer controller 161 supplying an image signal DAT_{P} is connected to the selector 12. The image processing section 154 has a transforming look up table 14 to which an attribute signal TAG of the printer controller 161 is supplied. The transforming look up table 14 transforms the attribute signal TAG into an identifying signal DSC_{P} having the same standard as the aforementioned identifying signal DSC_{C}, and outputs it to the selector 12.

A set of the image signal DAT and the identifying signal DSC, which is selected from the image signal DAT_{C} and the identifying signal DSC_{C} from the scanner or the image signal DAT_{P} and the identifying signal DSC_{P} from the printer controller 161, is supplied to an output high image quality processing section 13. Further, the image signal DAT, which is made to have a high image quality at the output high image quality processing section 13, and a control signal POS are supplied to the printer engine 104.

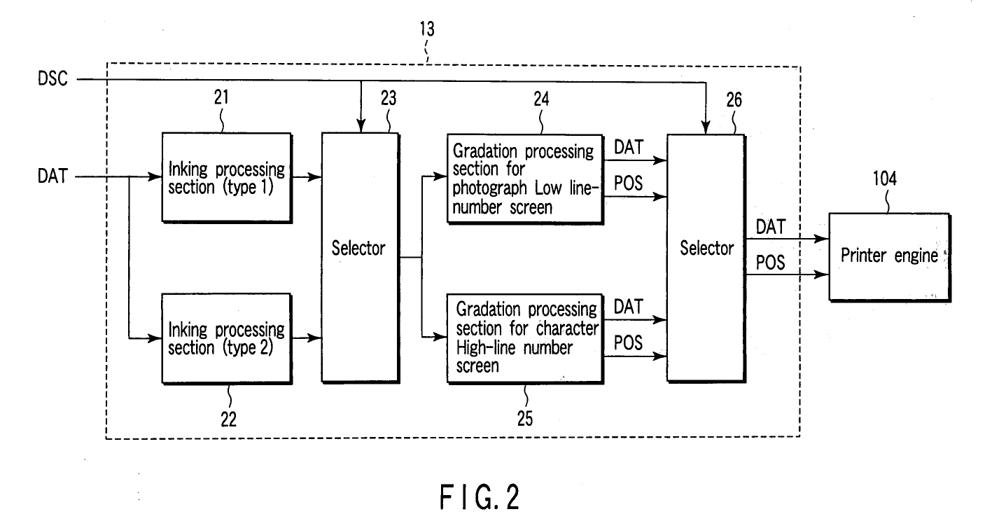

Moreover, FIG. 2 is a block diagram showing internal processing switching of the output high image quality processing section 13. In FIG. 2, the output high image quality processing section 13 has a type 1 inking processing section 21 and a type 2 inking processing section 22 to which the image signals DAT are respectively supplied, and the outputs thereof are supplied to the selector 23. Moreover, the output high image quality processing section 13 has a gradation processing section for photograph 24 having a low line-number screen and a gradation processing section for character 25 having a high line-number screen to which the outputs of the selector 23 are respectively supplied, and further has a selector 26 to which the image signal DAT and the control signal POS are supplied respectively therefrom, and supplies the selected one set of the image signal DAT and the control signal POS to the printer engine 104. Moreover, identifying signals DSC are supplied to the respective selectors 23, 26.

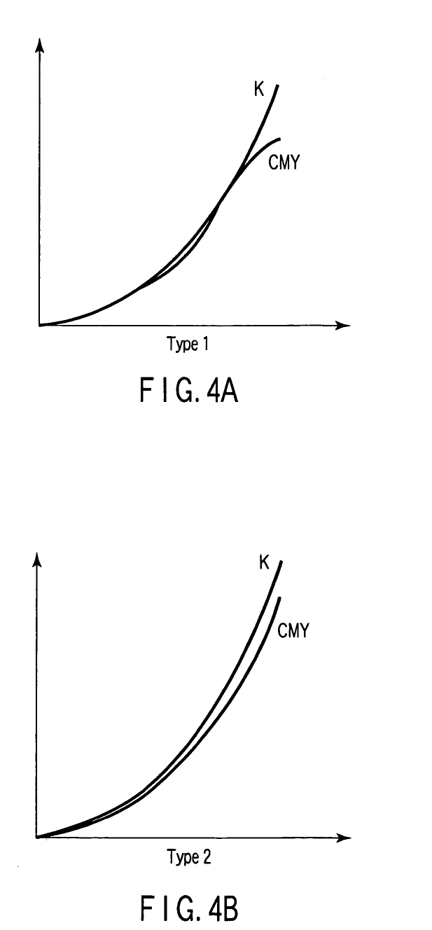

Here, the processing of the type 1 inking processing section 21 is shown by graph of FIG. 4A, and the processing of the type 2 inking processing section 22 is shown by graph of FIG. 4B.

(Explanation of Operation)

In such a structure, the image forming apparatus according to the present invention operates as will be described hereinafter. Namely, at the time of copying, the image signal from the scanner 103 is transformed into the image signal DAT_{C} and the identifying signal DSC_{C} by the input high image quality processing and the region identifying processing of the input high image quality processing section/region identifying processing section 11. Here, the identifying signal DSC_{C} is the result by which a photograph region, a character region, and color characters and black characters in the image signal from the scanner are identified.

The image signal DAT_{C} and the identifying signal DSC_{C} are supplied to the selector 12, and are selected at the time of copying, and are supplied to the output high image quality processing section 13 at the subsequent stage.

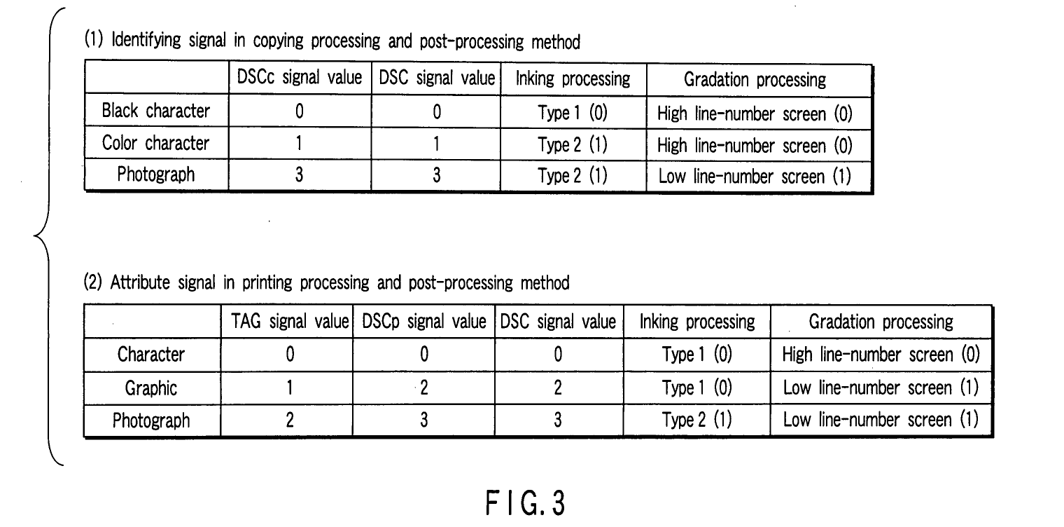

The output high image quality processing section at the subsequent stage is structured as in FIG. 2 as described above, and as shown in (1) of FIG. 3, the internal processings of the inking processing and the gradation processing are switched in accordance with the values of the identifying signal DSC. Namely, in the case of a black character, in the inking processing, the output of the type 1 inking processing section 21 is selected by the selector 23, and in the gradation processing, the processed result by the high line-number screen of the gradation processing section for character 25 is selected by the selector 26.

Namely, as shown in FIG. 3, in the inking processing, by switching the selectors 23 and 26 in the internal processing, switching is carried out between an ink table in which the K plate is greater than the CMY plates at the high density portions of type 1 and the reproducibility of the black characters is good, and an ink table in which there is little difference in the amounts of the CMYK plates at the high density portions of type 2 and the saturation is preserved.

The results of the output high image quality processing section 13 carrying out such processings are supplied to the printer engine 104 as the image signal DAT and the control signal POS, and an image is formed on a recording medium by the printer engine 104, and is outputted. In accordance therewith, the copying processing is carried out.

On the other hand, a case in which image formation is carried out by the image signal DAT_{P}, which is inputted via the printer controller 161, and the attribute signal TAG will be described. The image signal DAT_{P} is directly supplied to the selector 12. The attribute signal TAG is supplied to the transforming look up table 14, and is transformed into the identifying signal DSC_{P} having the same standard as that of the above identifying signal DSC. Namely, as shown by (2) of FIG. 3, the attribute signal TAG to which one of the three states (character, graphic, photograph) is allocated for each pixel is replaced with the states of the three identified results (black character, color character, photograph) used for the copying function in order to correspond to the three states (black character, color character, photograph) shown by the identifying signal DSC in the high image quality processing at the subsequent stage.

Namely, the TAG signal value “0” denoting a character is transformed into the DSC signal value “0”, and the TAG signal value “1” denoting a graphic is transformed into the DSC signal value “2”, and the TAG signal value “2” denoting a photograph is transformed into the DSC signal value “3”.

Due to the attribute signal TAG being transformed into the identifying signal DSC by the table transforming processing, the hardware resources in the inking processing and the gradation processing of the output high image quality processing section 13 at the subsequent stage can be used in common. The following processings are handled in the same way as the copying processings described above. The image signal and the control signal which passed through the high image quality processing are supplied to the printer engine 104, and image formation of the image signal from the printer controller 161 is possible. Accordingly, due to such a processing, there can be provided an image forming apparatus and an image forming method which can realize a reduction in costs due to a processing of identifying information of a copying function and a processing of identifying information of a printer function being made common.

Note that, in the above description, the identifying signal DSC_{C} relating to the image signal DAT_{C} from the scanner 103 is not table-transforming processed. However, it is possible to table-transforming process only the signal from the scanner 103, or both the signal from the scanner 103 and the signal from the printer controller 161 may be table-transforming processed and may be made common. Furthermore, the image signal which is handled is not limited to the signal from the scanner 103 and the signal from the printer controller 161, and for example, may be a signal of another format such as an image signal via a facsimile or communication device, or the like, and the same operation and effects of the present invention are exhibited by the same gist.

In accordance with the various embodiments described above, those skilled in the art can realize the present invention. However, it is easy for those skilled in the art to further conceive of various modified examples of these embodiments, and the present invention can be applied to various embodiments without inventive ability. Accordingly, the present invention extends over a broad range which does not contradict the disclosed principles and the novel features, and is not limited to the embodiments described above.

As described above in detail, in accordance with the present invention, due to processing for identifying information of the copying function and processing for identifying information of the printer function being made to be common, an image forming apparatus which can reduce costs and a method thereof can be provided.

What is claimed is:

1. An image forming apparatus comprising:
an identifying section which receives first image information, carries out region identifying processing of the first image information, and outputs a first region identifying signal;
a transforming section which receives second image information that is different from the first image information and attribute information of the second image information, and transforms the attribute information into a second region identifying signal of a standard common with that of the first region identifying signal by using a transforming table; and
an image forming section which receives at least one of the first image information and the first region identifying signal, and the second image information and the second region identifying signal, and which, on the basis thereof, carries out image formation on a recording medium.

2. An image forming apparatus comprising:
an identifying section which receives first image information from a scanner, carries out region identifying processing of the first image information, and outputs a first region identifying signal;
a transforming section which receives second image information from a printer controller and attribute information of the second image information, and transforms the attribute information into a second region identifying signal of a standard common with that of the first region identifying signal by using a transforming table; and
an image forming section which receives at least one of the first image information and the first region identifying signal, and the second image information and the second region identifying signal, and on the basis thereof, carries out image formation on a recording medium.

3. An image forming apparatus according to claim 2, wherein the identifying section further has a transforming section which transforms the first region identifying signal into predetermined identifying information, and the transforming section transforms the attribute information into identifying information of the same standard as that of the predetermined identifying information.

4. An image forming apparatus according to claim 2, wherein the image forming section includes an inking processing section which selects one inking processing from among a plurality of inking processings in accordance with the first or second region identifying signal, and applies the selected inking processing to the first or second image information.

5. An image forming apparatus according to claim 2, wherein the image forming section includes a gradation processing section which selects one gradation processing from among a plurality of gradation processings in accordance with the first or second region identifying signal, and applies the selected gradation processing to the first or second image information.

6. An image forming method comprising:
an identifying step of receiving first image information, carrying out region identifying processing of the first image information, and outputting a first region identifying signal;
a transforming step of receiving second image information that is different from the first image information and attribute information of the second image information, and transforming the attribute information into a second region identifying signal of a standard common with that of the first region identifying signal by using a transforming table; and
an image forming step of receiving at least one of the first image information and the first region identifying signal, and the second image information and the second region identifying signal, and on the basis thereof, carrying out image formation on a recording medium.

7. An image forming method comprising:
an identifying step of receiving first image information from a scanner, carrying out region identifying processing of the first image information, and outputting a first region identifying signal;
a transforming step of receiving second image information from a printer controller and attribute information of the second image information, and transforming the attribute information into a second region identifying signal of a standard common with that of the first region identifying signal by using a transforming table; and
an image forming step of receiving at least one of the first image information and the first region identifying signal, and the second image information and the second region identifying signal, and on the basis thereof, carrying out image formation on a recording medium.
